(19) United States
(12) Patent Application Publication
(10) Pub. No.: US 2005/0229742 A1
(43) Pub. Date: Oct. 20, 2005

(54) Sound-proof structure in power unit

(75) Inventors: Hirokazu Komura, Wako-shi (JP); Keiichiro Niizuma, Wako-shi (JP); Mitsunobu Kaneko, Wako-shi (JP); Eiji Kinbara, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 11/106,165

(22) Filed: Apr. 13, 2005

(30) Foreign Application Priority Data
Apr. 20, 2004 (JP) 2004-124480

(51) Int. Cl. G10K 11/16

(52) U.S. Cl. 74/606 R

(57) ABSTRACT

A sound proof structure is provided at the engine main body of a power unit in which the transmission case forming the storing chamber storing a transmission covers a part of the engine main body from a side part and is cooperatively arranged to extend toward the driving wheel, and the sound-proof cover covering the outer face of the transmission case is fixed to the transmission case, and noise released from the transmission case is sufficiently restricted by a simple structure.

### FIELD OF THE INVENTION

This invention relates to a power unit in which a transmission case forming a storing chamber storing a transmission is cooperatively arranged at an engine main body in such a way that it may cover a part of the engine main body from a side portion and extend toward a driving wheel and a sound-proof cover covering an outer side face of the transmission case is fixed to the transmission case and more particularly to an improvement of the sound-proof structure in which noise from the transmission case is prevented from being generated.

### BACKGROUND OF THE INVENTION

There have been already known in Japanese Patent No. 2796105 and Japanese Patent No. 3156079 that a sound absorbing material is held between an outer side face of the transmission case and a sound-proof cover covering the outer side face of the transmission case.

However, the aforesaid prior art shows that the sheet-like sound absorbing material is held between the transmission case and the sound-proof cover, noise released from the transmission case is merely absorbed by the sound absorbing material to restrict occurrence of noise and so it is hard to say that an effect of preventing noise is sufficiently attained.

The present invention has been invented in view of such circumstances as described above, and it is an object of the present invention to provide a sound-proof structure in a power unit capable of sufficiently restricting against noise released from the transmission case under application of a simple structure.

### SUMMARY OF THE INVENTION

In order to accomplish the aforesaid object, the invention provides a sound proof structure in a power unit in which a transmission case forming a storing chamber storing a transmission is cooperatively arranged at an engine main body in such a way that it covers a part of the engine main body from a side portion and extend up to a driving wheel and a sound-proof cover covering an outer side face of the transmission case fixed to the transmission case characterized in that sound-proof members defining a space between the transmission case and the sound-proof cover into plural spaces including at least one closed space are arranged between the transmission case and the sound-proof cover.

Noise released from the transmission case is absorbed and restricted by the sound-proof material arranged between the transmission case and the sound-proof cover and at the same time the noise is restricted by preventing a sound resonance from being generated in at least one closed space formed between the transmission case and the sound-proof cover, and so a sufficient noise preventing effect can be attained by a simple structure where a space between the transmission case and the sound-proof cover is defined into plural spaces.

In addition, the sound proof structure is characterized in that one surface of the sound-proof members formed into stripes through cutting and forming of a urethane sheet is bonded to any one of the transmission case and the sound-proof cover with adhesive agent.

By forming the sound-proof material into stripes through cutting and forming of a urethane sheet, a yield when the sound-proof material is formed can be increased as compared with the prior art case using the sheet-like sound-proof material having a shape corresponding to the shape of the sound-proof cover and further the sound-proof cover can be fixed to the transmission case in a state where the sound-proof material is adhered to either the transmission case or the sound-proof cover, resulting in that a productivity during assembling of the power unit is improved.

Further, the sound proof structure is characterized in that the transmission is a V-belt type automatic transmission including a driving pulley device and a driven pulley device, and a surrounding air intake port for use in taking cooling air into the storing chamber is arranged at a part opposed to the driving pulley device and at a side wall of the transmission case, the sound-proof cover is formed at a side corresponding to the driven pulley device into a shape covering a substantial half of the outer side face of the transmission case. It is possible to increase productivity by enabling the sound-proof member to be arranged between the transmission case and the sound-proof cover without considering the surrounding air intake port arranged at the transmission case.

### BRIEF DESCRIPTION OF THE DRAWINGS

FIG. 1 This is a side elevational view for showing a power unit and a rear wheel.

FIG. 2 This is a sectional view taken along line 2-2 of FIG. 1.

FIG. 3 This is a substantial part enlarged view of FIG. 2.

FIG. 4 This is a sectional view taken along line 4-4 of FIG. 3.

FIG. 5 This is a sectional view taken along line 5-5 of FIG. 3.

FIG. 6 This is an enlarged cross sectional view of a driven pulley device.

FIG. 7 This figure shows a case cover and a sound-proof cover from an arrow direction taken along line 7-7 of FIG. 2.

FIG. 8 This figure shows a case cover and a sound-proof cover from an arrow direction taken along line 8-8 of FIG. 2.

FIG. 9 This figure shows a test result of a noise generated state.

### DETAILED DESCRIPTION OF THE INVENTION

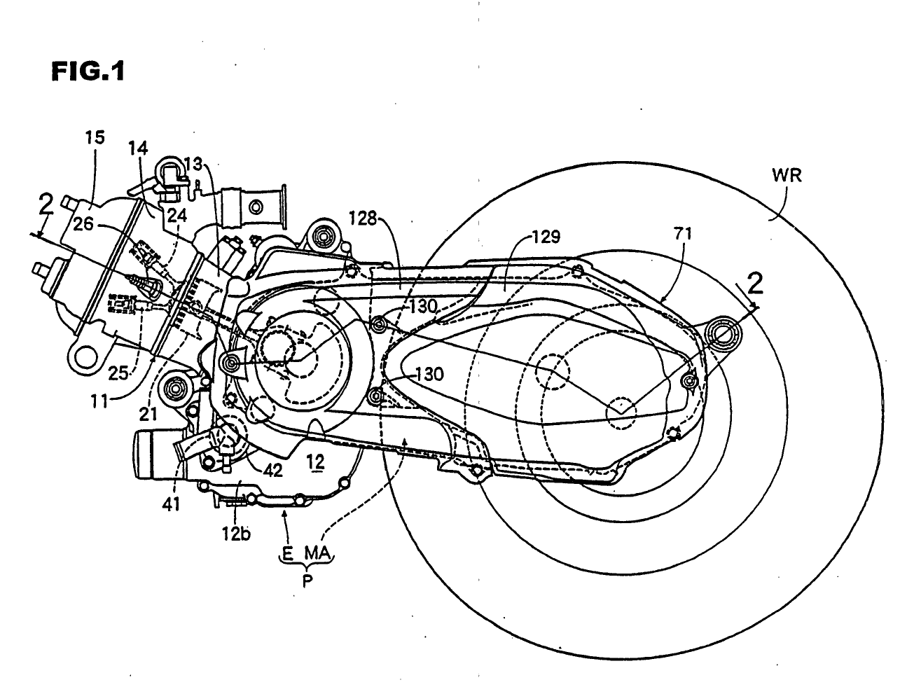

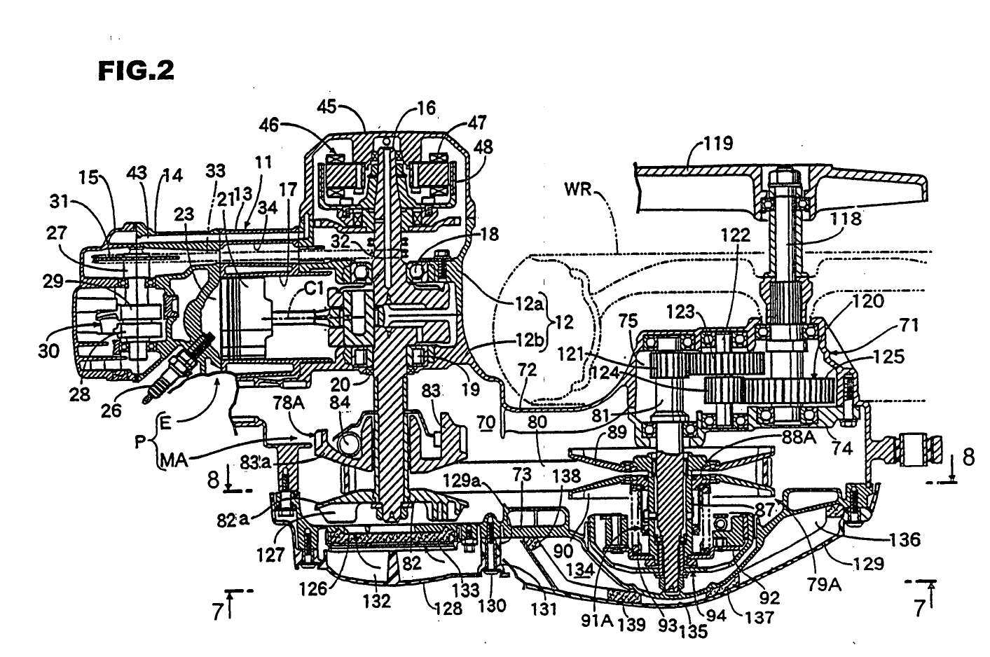

At first, in FIGS. 1 and 2, a power unit P constituted by an engine E arranged at a forward part of a rear wheel WR acting as a driving wheel and a V-belt type automatic transmission M installed between the engine E and the rear wheel WR is mounted on a chassis frame (not shown) of a scooter type motorcycle, and the rear wheel WR arranged at the rear right portion of the power unit P is pivotally supported at the rear part of the power unit P.

An engine main body 11 of the engine E comprises a crank case 12 for rotatably supporting a crank shaft 16 having a rotating axis line in parallel with a rotating axis line of the rear wheel WR, a cylinder block 13 connected to the crank case 12, a cylinder head 14 connected to the cylinder block 13 at a side opposite to the crank case 12 and a head cover 15 connected to the cylinder head 14 at a side opposite to the cylinder block 13.

The cylinder block 13 is arranged such that an axis line of the cylinder bore 17 set at the cylinder block 13, i.e. a cylinder axis line C1 is slightly raised at a front part along a forward or rearward direction of the motorcycle and becomes substantially to occupy a horizontal state. In addition, the crank case 12 comprises a pair of case half members 12a, 12b also including the cylinder axis line C1 and connected at a plane crossing at a right angle with an axis line of the crank shaft 16, a ball bearing 18 is installed between one case half member 12a of one of both case half members 12a, 12b and the crank shaft 16, and further a roller bearing 19 and an annular seal member 20 arranged more outside than that of the roller bearing 19 are installed between the other case half member 12b and the crank shaft 16.

A combustion chamber 23 is formed between the cylinder head 14 and a piston 21 slidably fitted in the cylinder bore 17. An intake valve 24 for controlling intake gas fed into the combustion chamber 23 and an exhaust valve 25 for controlling exhaust gas discharged out of the combustion chamber 23 are arranged at the cylinder head 14 in such a way that they may be arranged in a substantial V-shape on a projected figure for a plane crossing at a right angle with the rotating axis line of the crank shaft 16. A spark plug 26 adjacent to the combustion chamber 23 is fixed to the left side face of the cylinder head 14 in a state where it is faced in a forwarding direction of the motorcycle.

Between the cylinder head 14 and the head cover 15 is stored a valve train 30 having an axis line in parallel with an axis line of the crank shaft 16, rotatably supported at the cylinder head 14 and including a cam shaft 27 having an intake cam 28 and an exhaust cam 29 so as to drive to open or close the intake valve 24 and exhaust valve 25.

To one end of the cam shaft 27 is fixed a driven sprocket 31. In turn, the first driving sprocket 32 is fixed at such a position as one corresponding to the driven sprocket 31 at a more outside than that of the ball bearing 18 at the crank shaft 16. An endless cam chain 33 is wound around the first driving sprocket 32 and the driven sprocket 31. The cam chain 33 is stored in a chain chamber 34 formed over the cylinder block 13, cylinder head 14 and head cover 15 in such a way that the cam chain can run there. The cam shaft 27 is rotationally driven under the number of rotation of ½ of that of the crank shaft 16 by the first driving sprocket 32, the driven sprocket 31 and the cam chain 33.

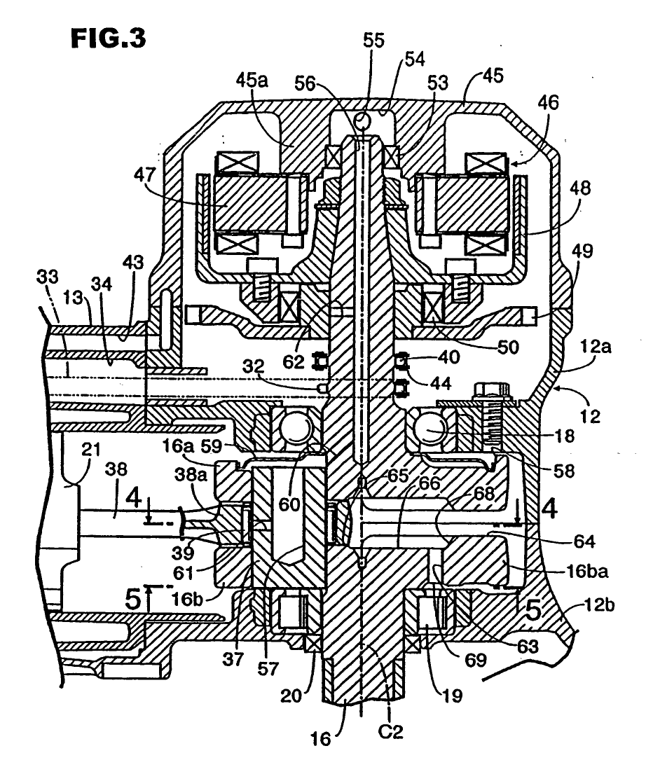

Referring now also to FIG. 3, the crank shaft 16 is provided with a pair of crank webs 16a, 16b oppositely faced to each other while being axially spaced apart, and both ends of the crank pin 37 are connected to these crank webs 16a, 16b. In turn, one end of a connecting rod 38 is connected to the piston 21, and the other end of this connecting rod 38, i.e. a large end 38 is connected to the crank pin 37 through a needle bearing 39.

The second driving sprocket 40 is fixed to the crank shaft 16 at a more outside part than that of the first driving sprocket 31. In turn, an oil pump 41 (refer to FIG. 1) for use in sucking up oil from the lower portion in the crank case 12 and a cooling water pump 42 (refer to FIG. 1) for use in circulating cooling water to a cooling jacket 43 arranged at the cylinder block 13 and the cylinder head 14 are coaxially arranged at the lower portion of the crank case 12 and then a rotating force is transmitted from the second driving sprocket 40 to the oil pump 41 and the cooling water pump 42 through the chain 44.

At a more outside location than that of the second driving sprocket 40, there is provided a generator 46 comprising a stator 47 fixed to a right cover 45 attached to the right side face of the crank case 12 and an outer rotor 48 fixed to the crank shaft 16 so as to enclose the stator 47.

A driven gear 49 coaxially enclosing the crank shaft 16 and supported by the crank shaft 16 in such a manner that it can be rotated relatively is arranged between the second driving sprocket 40 and the outer rotor 48, and this driven gear 49 is connected to the outer rotor 48 through one-way clutch 50. In this way, a rotational driving force provided by a starter motor not shown can be inputted to the driven gear 49 and when the engine E starts to operate, a driving force from the starter motor is transmitted to the crank shaft 16 at the time of starting operation of the engine E, and the driving force from the crank shaft 16 is not transmitted to the scooter motor under an action of the one-way clutch after starting an operation of the engine E.

A cylindrical supporting cylinder 45a enclosing the right end of the crank case 12 is integrally protruded at the central part of an inner face of the right cover 45, an annular seal member 53 is arranged between the supporting cylinder 45a and the crank shaft 16, an oil chamber 54 into which the right end of the crank shaft 16 protrudes is formed at the central part of an inner face of the right cover 45, and an oil passage 55 arranged at both crank case 12 and right cover 45 is communicated with this oil chamber 54 in such a way that oil from the oil pump 41 may be guided.

The crank shaft 16 has coaxially the first oil passage hole 56 with a bottom part having its outer end communicated with the oil chamber 54 in such a way that its inner end is closed at a position substantially corresponding to the ball bearing 18. In addition, the crank pin 37 has coaxially the second oil passage hole 57 with a bottom part released to the ball bearing 18 for its light weight formation and supplying oil. In turn, the outer face of one crank web 16a of the crank shaft 16 facing against the ball bearing 18 is formed with an annular fixing concave part 58 adjacent to an opening end of the second oil passage hole 57, and the outer circumference of an annular oil delivering plate 59 formed like a dish shape is press fitted and fixed against the fixing concave part 58 so as to cover the opening end of the second oil passage hole 57.

In addition, the crank shaft 16 has the first communication hole 60 punched to cause the oil from the first oil passage hole 56 to be fed between the oil delivering plate 59 and the crank web 16a. Further, the crank pin 37 is provided with the second communication hole 61 for feeding the oil in the second oil passage hole 57 to the needle bearing 39.

Accordingly, the oil fed from the oil pump 41 to the oil chamber 54 through the oil passage 55 is supplied to the needle bearing 39 through the first oil passage hole 56, first communication hole 60, between the oil delivering plate 59 and the crank web 16a, second oil passage hole 57 and second communication hole 61. In addition, the crank shaft 16 is also provided with the third communication hole 62 for use in feeding the oil from the first oil passage hole 56 to a part between the crank shaft 16 and the driven gear 49.

Although the oil supplied to the needle bearing 39 is used for applying a lubrication between the large end part 38a of the connecting rod 38 and the crank pin 37, the oil splashes as the crank shaft 16 is rotated, the oil hole 63 for use in feeding a part of the splashed oil to the roller bearing 19 has an axis line in parallel with the axis line of the crank shaft 16 and is arranged at the other crank web 16b.

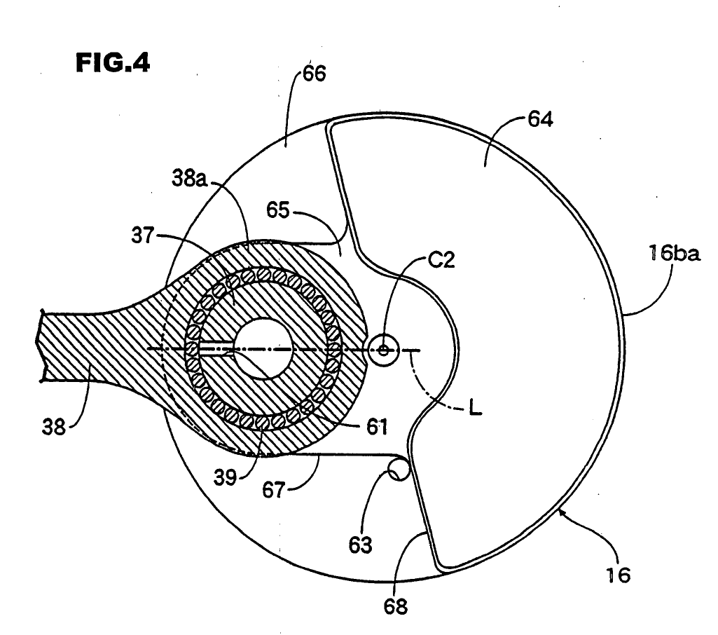

Also referring to FIG. 4, the other aforesaid crank web 16b is provided with a weight part 16ba at a side opposite to a connected part of the crank pin 37 in regard to the axis line C2 of the crank shaft 16. The inner face of this crank web 16b comprises an arcuate higher level surface 64 corresponding to the weight part 16ba, a middle level surface 65 extending in parallel with a straight line L passing through an axis line of the crank pin 37 and through an axis line C2 of the crank shaft 16 and further extending in a band-like manner between the connected part of the crank pin 37 and the weight part 16ba, and another low level surface 66. The middle level surface 65 forms a step part 67 between it and the low level surface 66 and is formed to be slightly more inwardly protruded than that of the low level surface 66. The higher level surface 64 forms a step part 68 between the low level surface 66 and the middle level surface 65 and is formed to be protruded more inwardly than that of the middle level surface 65.

Thus, one end of the oil hole 63 is opened at the low level surface 66 near a location where both the steps 67, 68 are curved and connected to each other, oil splashed from the needle bearing 39 is transmitted along the steps 67, 68 and easily guided to one end of the oil hole 63.

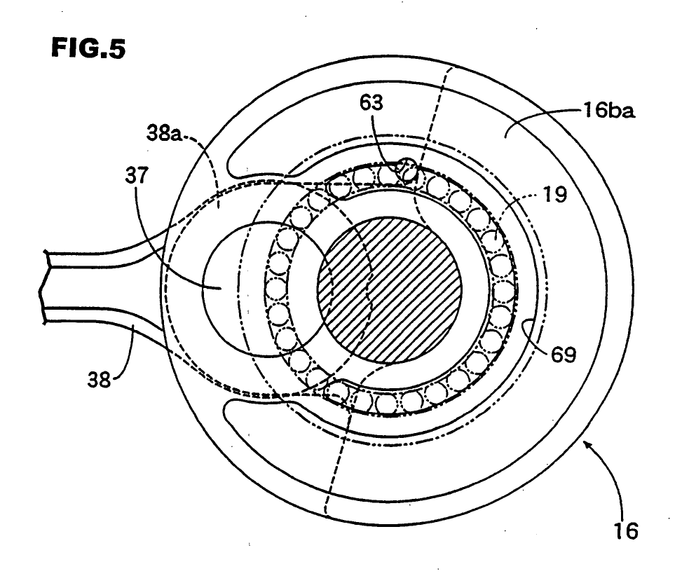

Also referring to FIG. 5, the outer face of the other aforesaid crank web 16b oppositely facing against the roller bearing 19 is provided with a cavity 69 formed in an arcuate manner substantially corresponding to the roller bearing 19, and the other end of the oil hole 63 is opened at the cavity 69. Thus, oil fed from the oil hole 63 is easily accumulated at the cavity 69 and splashed from the cavity 69 to the roller bearing 19, thereby oil can be supplied to the roller bearing 19.

Referring again to FIG. 2, the V-belt type automatic transmission M is stored in a storing chamber 70 in a transmission case 71 covering a part of the engine main body 11 from its side part to be cooperatively arranged at the engine main body 11 and extending to the left side of the rear wheel WR. The transmission case 71 comprises an inner case 72 integrally cooperated with the other case half member 12b of a pair of case half members 12a, 12b constituting the crank case 12, an outer case 73 fastened to the inner case 72 so as to cover the inner case 72 from outside and a gear reducer case 74 fastened to the rear part of the inner case 72 within the outer case 73. The storing chamber 70 is formed among the inner case 72, gear reducer case 74 and outer case 73, and a gear chamber 75 is formed between the inner case 72 and the gear reducer case 74.

The V-belt type automatic transmission M comprises a driving pulley device 78 installed at the other end of the crank shaft 16 protruded from the crank case 12 into the storing chamber 70, a driven pulley device 79 having an axis line in parallel with the crank shaft 16 and installed at an output shaft 81 rotatably supported by an inner case 72 and a gear reducer case 74, and an endless V-belt 80 for transmitting a driving power from the driving pulley device 78 to the driven pulley device 79.

The driving pulley device 78 comprises a fixed half-pulley member 81 fixed to the crank shaft 16, a movable half-pulley member 82 that can approach to or be spaced apart from the fixed half-pulley member 81 and a centrifugal weight 83 moved in a radial outward direction in response to an increasing in the number of rotation of the crank shaft 16. The movable half-pulley member 82 is biased in such a direction as one in which it approaches to the fixed half-pulley member 81 while the centrifugal weight 83 moves in a radial outward direction in response to an increasing in the number of rotation of the crank shaft 16.

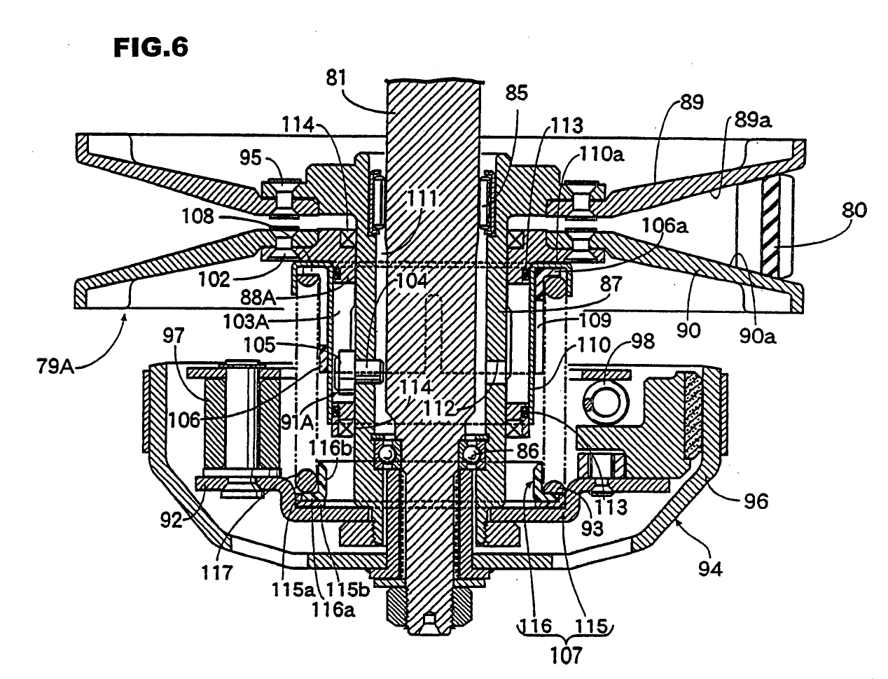

In FIG. 6, the driven pulley device 79 comprises an inner cylinder 87 coaxially enclosing an output shaft 81 while installing a needle bearing 85 and a ball bearing 86 between it and the output shaft 81, an outer cylinder 88 enabling a relative rotation around an axis line and a relative motion in an axial direction and fitting the inner cylinder 87 in a slidable manner, a fixed half-pulley member 89 fixed to the inner cylinder 87, a movable half-pulley member 90 fixed to the outer cylinder 88 while being oppositely faced against the fixed half-pulley member 89, a torque cam mechanism 91 arranged between the inner cylinder 87 and the outer cylinder 88 while a partial force in an axial direction being applied between both half-pulley members 89, 90 in response to a relative rotational phase difference between the movable half-pulley member 90 and the fixed half-pulley member 89, a spring receiving member 92 fixed to the inner cylinder 87 at a position where the movable half-pulley member 90 is held between it and the fixed half-pulley member 89, a coil spring 93 enclosing the outer cylinder 88, shrunk and arranged between the movable half-pulley member 90 and the spring receiving member 92, and a centrifugal clutch 94 arranged between the inner cylinder 87 and the output shaft 81 while a power transmitting state is attained as the number of rotation of the engine exceeds a predetermined number of rotation.

Then, the V-belt 80 is held between the oppositely facing conical faces 81a, 82a of the fixed half-pulley member 81 and the movable half-pulley member 82 at the driving pulley device 78 and between the oppositely facing conical faces 89a, 90a of the fixed half-pulley member 89 and the movable half-pulley member 90 at the driven pulley device 79. At the driving pulley device 78, a winding radius of the V-belt 80 to the fixed and movable half-pulley members 81, 82 is increased as the movable half-pulley member 82 approaches to the fixed half-pulley member 81 in response to an increasing in the number of rotation of the crank shaft 16, and correspondingly at the driven pulley device 79, a winding radius of the V-belt 80 to the fixed and movable half-pulley members 89, 90 is decreased.

The fixed half-pulley member 89 is fixed to one end of the inner cylinder 87 with plural rivets 95, and the spring receiving member 92 is fixed to the other end of the inner cylinder 87. Thus, the spring receiving member 92 also constitutes a part of the centrifugal clutch 94. The centrifugal clutch 94 comprises a cup-like clutch outer 96 fixed to the other end of the output shaft 81, centrifugal weights 97 enabled to be turned around an axis line in parallel with the output shaft 81 and pivotally supported at plural locations of the spring receiving member 92 and clutch springs 98 arranged between each of the centrifugal weights 97 and the spring receiving members 92. The inner cylinder 87, i.e. the fixed half-pulley member 89 and the clutch outer 96, i.e. the output shaft 81 are connected to each other by frictionally engaging the centrifugal weights 97 with the clutch outer 96 when the centrifugal force acting on each of the centrifugal weights 97 in response to a rotation of the spring receiving member 92 exceeds a spring biasing force of each of the clutch springs 98.

The movable half-pulley member 90 is fixed to one end of the outer cylinder 88 with plural rivets 102 so as to be oppositely faced against the fixed half-pulley member 89. In addition, the torque cam mechanism 91 is a well-known prior art mechanism comprising cam holes 103 arranged at plural locations of the outer cylinder 88, cam pins 104 implanted into the inner cylinder 87 while being inserted into these cam holes 103, and rollers 105 pivotally supported at the cam pins 104 rolled in the cam holes 103.

Thus, a clearance between the fixed half-pulley member 89 at the driven pulley device 79 and the movable half-pulley member 90 is determined by a balance among an axial force generated by the torque cam mechanism 91, an axial resilient force generated by the coil spring 93 and a force from the V-belt 80 acted in such a direction as one spaced by the clearance between the fixed half-pulley member 89 and the movable half-pulley member 90.

The inner circumference of the coil spring 93 at the movable half-pulley member 90 is guided by the guide member 106, and a thrust bearing means 107 is arranged between the spring receiving member 92 and the coil spring 93.

The guide member 106 has at its one end a flange 106a for receiving one end of the coil spring 93 facing at the movable half-pulley member 90 and is formed into a cylindrical shape by self-lubricating resin. One end of the coil spring 93 is received by the flange 106a of the guide member 106 and further the inner circumference of the coil spring 93 at the movable half-pulley member 90 is guided by the guide member 106. In addition, the guide member 106 is provided with plural slits 108 extending from its one end to the other end and plural slits 109 extending from the other end to one end.

In addition, among the movable half-pulley member 90, the outer cylinder 88 and the guide member 106 having the flange 106a is present a metallic collar 110 receiving a flange 106a of the guide member 106, inserting one end of the coil spring 93, having integrally at one end a receiving part 110a formed into a substantial L-shape in its longitudinal section and formed into a cylindrical shape. This collar 110 coaxially encloses the outer cylinder 88 while closing from outside the cam holes 103 arranged in the outer cylinder 88.

In regard to this arrangement, grease is filled in each of the cam holes 103 and an annular chamber 111 formed between the output shaft 81 and the inner cylinder 87 between the needle bearing 85 and the ball bearing 86. The inner cylinder 87 is provided with communication holes 112 connecting between the annular chamber 111 and each of the cam holes 103. Annular seal members 113, 113 resiliently contacted with the inner circumference of the collar 110 are installed at both outer circumferential ends in an axial direction of the outer cylinder 88, and the annular seal members 114, 114 slidably contacting with the outer circumference of the inner cylinder 87 are installed at both inner circumferential ends of the outer cylinder 88 in an axial direction.

The thrust bearing means 107 is made such that a pair of bearing members 115, 116 made of self-lubricating resin and overlapped to each other are held between the coil spring 93 and the spring receiving member 92, wherein one bearing member 115 has integrally a fitted cylindrical part 115a fitted to a circular cavity 117 arranged at the spring receiving member 92 and a flat plate ring-like bearing 115b contacted with a closing end of the cavity 117, and the other bearing member 116 is provided with a flat plate ring-like bearing 116a held between the bearing 115b and the coil spring 93, and a position setting cylinder 116b integrally cooperated at the inner circumference of the bearing 116a while its relative position with the coil spring 93 is defined by being inserted into the inner circumference at the other end of the coil spring 93.

Further, referring again to FIG. 2, a wheel shaft 118 of the rear wheel WR is rotatably supported at the gear reducer case 74 and the inner case 72, and the end part of the wheel shaft 118 protruded from the transmission case 71 is rotatably supported at an arm 119 connected to the engine main body 11 and arranged at the right side of the rear wheel WR.

A row of reduction gears 120 arranged between the output shaft 81 and the wheel shaft 118 is stored in the gear chamber 75, and the row of reduction gears 120 comprises the first gear 121 arranged at the output shaft 81, the second gear 123 arranged at an intermediate shaft 122 in parallel with the output shaft 81 and the wheel shaft 118 and rotatably supported at the inner case 72 and the gear reducer case 74 and engaged with the first gear 121, the third gear 124 arranged at the intermediate shaft 122 and the fourth gear 125 engaged with the third gear 124 and arranged at the wheel shaft 118.

The side wall of the outer case 73 at the transmission case 71 opposing against the driving pulley device 78 is provided with a surrounding air intake port 126 for use in taking cooling air into the storing chamber 70, and a cooling fan 127 for dispersing the cooling air taken at the surrounding air intake port 126 into the storing chamber 70 is integrally arranged at the outer circumference of the movable half-pulley member 90 at the driving pulley device 78.

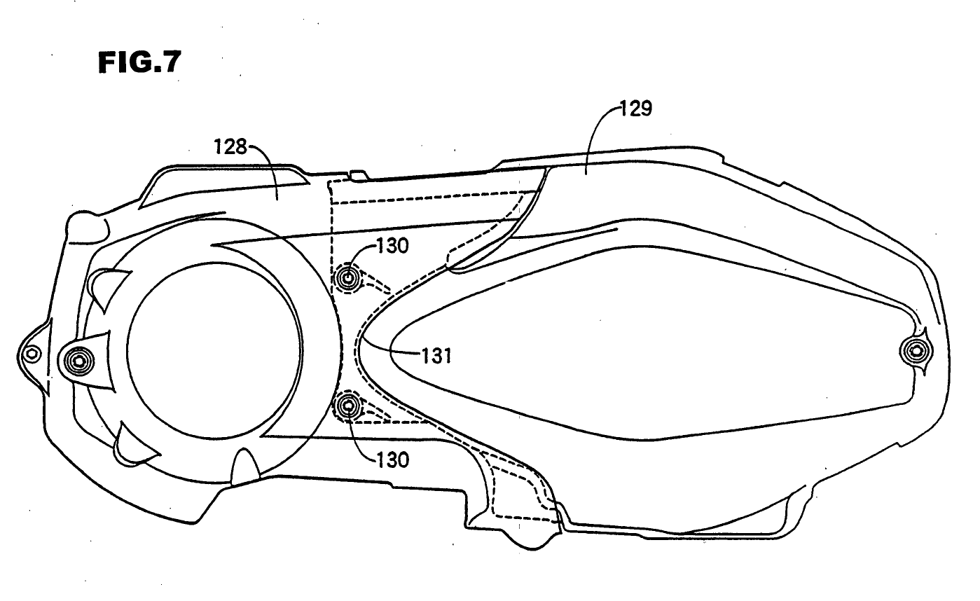

Also referring to FIG. 7, the outer face of the transmission case 71 is covered by the case cover 128 and the sound-proof cover 129. The case cover 128 includes a portion where the surrounding air intake port 126 is arranged and is fastened to the outer case 73 at the transmission case 71 at plural locations there while covering the outer face of the front half part of the transmission case 71. The sound-proof cover 129 is fastened to the outer case 73 at the transmission case 71 at plural locations so as to cover the outer face of the rear half part of the transmission case 71 at a side corresponding to the driven pulley device 79.

The case cover 128 and the sound-proof cover 129 are fixed to the transmission case 71 so as to cover the front edge of the sound-proof cover 129 at the rear edge of the case cover 128, two hubs 129a arranged at the front part of the sound-proof cover 129 are held between the rear part of the case cover 128 and the transmission case 71, and the rear part of the case cover 128 and the front part of the sound-proof cover 129 are fastened together to the transmission case 71 by the screw members 130.

Further, an intake port 131 opened at a rear side is formed between the rear edge of the case cover 128 and the front edge of the sound-proof cover 129, and an air feeding chamber 132 communicated with the intake port 131 is formed between the case cover 128 and the transmission case 71.

A filter 133 is fixed to the outer face of the transmission case 71 so as to close the surrounding air intake port 126 from the side of the air feeding chamber 132, the surrounding air fed from the intake port 131 to the air feeding chamber 132 passes through the filter 133 to be purified and then sucked into the storing chamber 70.

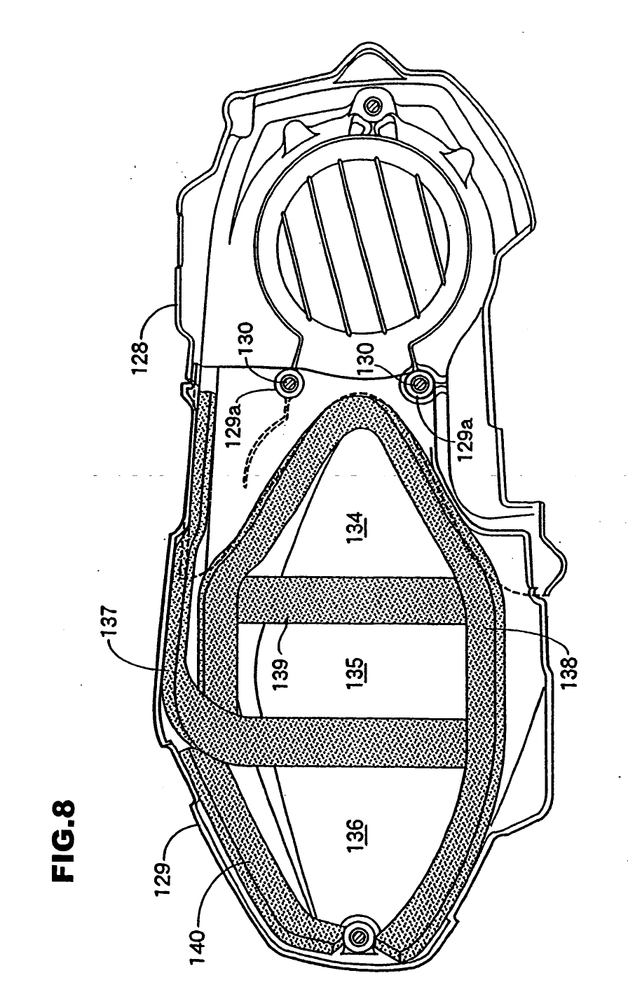

Referring also to FIG. 8, between the transmission case 71 and the sound-proof cover 129 are arranged, for example, four sound-proof members 137, 138, 139 and 140 so as to define a space between the transmission case 71 and the sound-proof cover 129 into plural spaces including at least a closed space, that is, in this embodiment, three closed spaces 134, 135 and 136.

Each of the sound-proof members 137 to 140 is formed into a stripe shape by cutting and forming a urethane sheet, respectively, and a surface of each of these sound-proof members 137 to 140 is adhered to any one of the transmission case 71 and the sound-proof cover 129 with adhesive agent, to the inner face of the sound-proof cover 129 in this preferred embodiment.

Then, an action of the preferred embodiment will be described as follows. At least, the inner circumference of the coil spring 93 is guided by a guide member 106 at the movable half-pulley member 90 in the driven pulley device 79 of the V-belt type automatic transmission M and the thrust bearing means 107 is present between the spring receiving member 92 and the coil spring 93, so that it is possible to rotate the coil spring 93 together with the movable half-pulley member 90 so as to prevent a relative rotation in respect to the movable half-pulley member 90, and further it is also possible to prevent the coil spring 93 from being twisted. Further, the inner circumference of the coil spring 93 at the movable half-pulley member 90 is guided by the guide member 106, so that it is possible to prevent the coil spring 93 from generating a wavy phenomenon while a centering state of the inner circumference of the coil spring 93 is attained at the inner circumference of the coil spring 93.

In particular, an amount of work of the half-part of the movable half-pulley member 90 in the coil spring 93 becomes relatively high in response to an axial motion of the movable half-pulley member 90 and the inner circumference of the side where the amount of work becomes high is guided by the guide member 106, so that occurrence of pulsation state can be prevented more effectively.

In addition, the thrust bearing means 107 is made such that a pair of bearing members 115, 116 overlapped to each other are held between the coil spring 93 and the spring receiving member 92 and the thrust bearing means 107 can be constituted by a quite simple structure and further both bearing members 115, 116 are made of self-lubricating resin, so that an anti-wearing characteristic against dust can be improved even if cooling air fed into the storing chamber 70 contains dusts.

In addition, the guide member 106 is also formed by the self-lubricating resin, thereby a sliding between the inner circumference of the coil spring 93 and the guide member 106 at the movable half-pulley member 90 can be improved. As a result, it becomes possible to set a clearance between the coil spring 93 and the guide member 106 as less as possible, occurrence of pulsation phenomenon generated at the coil spring 93 can be prevented as more effectively as possible and its workability can be improved.

Further, since the metallic collar 110 is arranged among the movable half-pulley member 90, outer cylinder 88 and the guide member 106 receiving the end face of the coil spring 93 at the movable half-pulley member 90, a thickness of the guide member 106 can be set thin to facilitate a management over a clearance between it and the inner circumference of the coil spring 93 as the resin-made guide member 106 is thermally expanded, and additionally, it is possible to maintain a difference of frictional coefficient between it and the spring receiving member 92 and generate a more positive relative rotation between the coil spring 93 and the spring receiving member 92.

Additionally, a space between the transmission case 71 and the sound-proof cover 129 covering the outer side face of the transmission case 71 and fixed to the transmission case 71 is defined into plural spaces including at least a closed space, that is, in this embodiment, three closed spaces 134 to 136 by the sound-proof members 137 to 140. Therefore, noise produced from the transmission case 71 is absorbed and restricted by the sound-proof members 137 to 140 arranged between the transmission case 71 and the sound-proof cover 129, and at the same time, the noise is restricted by a sound resonance prevented from being generated by the plurality of closed spaces 134 to 136 formed between the transmission case 71 and the sound-proof cover 129. Accordingly, it is possible to attain a sufficient noise preventing effect with a simple structure in which a space between the transmission case 71 and the sound-proof cover 129 is defined into plural closed spaces 134 to 136 by the sound-proof members 137 to 140.

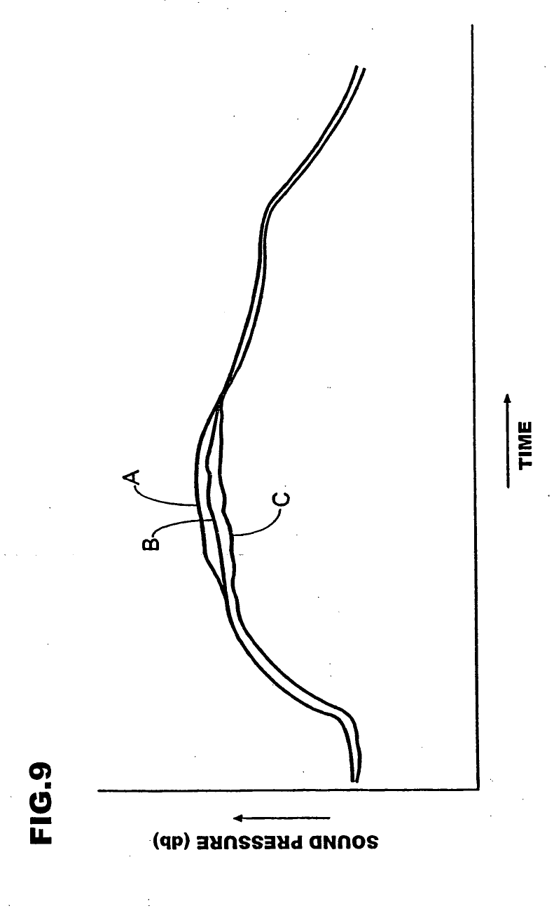

In regard to this point, it is apparent that, under an assumption that a state having no sound-absorbing member between the sound-proof cover 129 and the transmission case 71 is defined as A, a state having sound-absorbing member over a front face between the sound-proof cover 129 and the transmission case 71 is defined as B, and a state having a space between the sound-proof cover 129 and the transmission case 71 divided into plural closed spaces 134 to 136 by the sound-proof members 137 to 140 according to the present invention is defined as C, a test for checking an occurrence of noise at the time of acceleration of the motorcycle at each of the states A to C shows that a result indicated in FIG. 9 is attained and a superior noise-proof effect can be attained under the state C according to the present invention.

In addition, the sound-proof members 137 to 140 are formed into a stripe shape by cutting and forming a urethane sheet and one surface of each of these sound-proof members 137 to 140 is adhered to one of the transmission case 71 and the sound-proof cover 129, the sound-proof cover 129 in this preferred embodiment with adhesive agent. Yield when the sound-proof members 137 to 140 are formed can therefore be increased as compared with that of the prior art using a sheet-like sound-proof member with a shape corresponding to the shape of the sound-proof cover 129. In addition, the sound-proof cover 129 can be fixed to the transmission case 71 in a state where the sound-proof cover 129 can be fixed to the transmission case 71 in a state where the sound-proof members 137 to 140 are adhered to any one of the transmission case 71 and the sound-proof cover 129, resulting in that a productivity at the time of assembling the power unit P is improved.

Although a part of the V-belt type automatic transmission M stored in the storing chamber 70 opposing against the driving pulley device 78, i.e. a side wall of the transmission case 71 is provided with the surrounding air intake port 126 for use in taking the cooling air into the storing chamber 70, the sound-proof cover 129 is formed into such a shape as one covering a substantial half part of the outer face of the transmission case 71 at a side corresponding to the driven pulley device 79 at the V-belt type automatic transmission M. The sound-proof members 137 to 140 can therefore be arranged between the transmission case 71 and the sound-proof cover 129 without considering the surrounding air intake port 126 arranged at the transmission case 71 so as to enable a productivity to be increased.

Although the preferred embodiment of the present invention has been described as above, the present invention is not limited to the aforesaid preferred embodiment, and various modifications in design can be carried out without departing from a scope of the present invention described in the claim.

1. A sound-proof structure in a power unit in which a transmission case forming a storing chamber storing a transmission is cooperatively arranged at an engine main body in such a way that it covers a part of said engine main body from a side portion and extend up to a driving wheel and a sound-proof cover covering an outer side face of said transmission case fixed to the transmission case,
characterized in that sound-proof members defining a space between said transmission case and said sound-proof cover into a plurality of spaces including at least one closed space are arranged between said transmission case and said sound-proof cover.

2. The sound-proof structure in a power unit according to claim 1, characterized in that one surface of said sound-proof members formed into stripes through cutting and forming of a urethane sheet is bonded to any one of said transmission case and said sound-proof cover with adhesive agent.

3. The sound-proof structure in a power unit according to claim 1 characterized in that said transmission is a V-belt type automatic transmission comprising a driving pulley device and a driven pulley device, a surrounding air intake port for use in taking cooling air into the storing chamber is arranged at a part opposed to said driving pulley device and at a side wall of said transmission case, said sound-proof cover is formed at a side corresponding to said driven pulley device into a shape covering a substantial half of the outer side face of said transmission case.
